(19) United States
(12) Patent Application Publication
(10) Pub. No.: US 2025/0351759 A1
(43) Pub. Date: Nov. 20, 2025

(54) CONFIGURATION OF A ROW CROP CULTIVATOR ROW UNIT

(71) Applicant: MACDON INDUSTRIES LTD., Winnipeg (CA)

(72) Inventors: Karl Hundt, Lake Mills, WI (US); Nolan Lacy, Rio, WI (US)

(21) Appl. No.: 18/873,645

(22) PCT Filed: Jun. 12, 2023
(86) PCT No.: PCT/US2023/025024

§ 371 Date: Dec. 10, 2024

Related U.S. Application Data
(60) Provisional application No. 63/350,991, filed on Jun. 10, 2022.

(51) Int. Cl. A01B 35/18; A01B 35/24

(52) U.S. Cl. CPC A01B 35/18; A01B 35/24

(57) ABSTRACT

A row crop cultivator row unit (20) includes a frame (22), two front sweeps (24, 26) attached to the frame (22), and a rear sweep (28) that is attached to the frame (22), positioned rearwardly, and between the two front sweeps (24, 26). The two front sweeps (24, 26) are uniform in size, each having a maximum width identical to the other, and the rear sweep (28) has a maximum width that is larger than the front sweep maximum width. In an alternative embodiment, the row crop cultivator row unit includes a frame and a sweep attached to the frame. The attached sweep has a maximum width dimension in the range of 9-36 inches, a maximum height of 25 millimeters, and a sweep pitch angle in the range of 0° to 12°. In another alternative embodiment, the row crop cultivator row unit includes a frame and two sweeps attached to the frame. The two sweep have identical dimensions and each has a maximum width dimension in the range of 5-7 inches.

### CROSS-REFERENCE TO RELATED APPLICATIONS

This application claims priority to U.S. Provisional Application No. 63/350,991, filed Jun. 10, 2022.

### BACKGROUND OF THE INVENTION

### 1. Description of Related Art

Row crop cultivators for weeding agricultural crops that are grown in rows are known in the art. Typical row crop cultivator row units include multiple sweeps that are each uniform in size. The sweeps have dual purposes. First, the sweeps slice through the soil cutting through weeds to inhibit their growth. Second, the sweeps disrupt the soil causing the soil to pile on either side of each sweep into hills. This process is called hilling and the creation of these hills chokes out weed growth.

Row crop cultivators with smaller sweeps are typically known to be used earlier in the season when the crops are less mature because they cause less soil to be disrupted resulting in less damage to less mature crops. Row crop cultivators with larger sweeps are typically known to be used later in the season because they tend to disrupt the soil more aggressively, resulting in better hilling on more mature crops. Therefore, fanners may use different types of row crop cultivators depending upon the time within the season and maturity of the crops.

### 2. Summary of the Invention

According to one aspect of the invention, a row crop cultivator row unit is provided for use with an agricultural machine that includes a frame, two front sweeps attached to the frame, and a rear sweep attached to the frame, positioned rearwardly and between the two front sweeps, wherein the two front sweeps are uniform in size, each have a maximum width identical to the other, and the rear sweep has a maximum width that is larger than the front sweep maximum width.

According to another aspect of the invention, a row crop cultivator row unit is provided for use with an agricultural machine. The row crop cultivator row unit includes a frame and a sweep attached to the frame, wherein the sweep has a maximum width dimension in the range of nine (9) inches-thirty-six (36) inches, a maximum height of twenty-five (25) millimeters, measured from a lower surface to an upper surface, and a pitch angle in the range of zero degrees (0°) to twelve degrees (12°).

According to another aspect of the invention, a row crop cultivator row unit is provided for use with an agricultural machine. The row crop cultivator row unit includes a frame and two sweeps attached to the frame, wherein the two sweeps have identical dimensions and each sweep has a maximum width dimension in the range of five (5) inches to seven (7) inches.

### BRIEF DESCRIPTION OF THE DRAWINGS

Advantages of the present disclosure will be readily appreciated as the same becomes better understood by reference to the following detailed description when considered in connection with the accompanying drawings, wherein:

FIG. 1 is a perspective view of a row crop cultivator row unit according to one embodiment of the present invention;

FIG. 2a is a top view of the sweep configuration shown in FIG. 1 including the coil springs;

FIG. 2b is a top view of the sweep configuration shown in FIG. 1;

FIG. 3 is a side view of one embodiment of a rear sweep indicating a sweep height;

FIG. 4 is a side view of one embodiment of a rear sweep indicating a maximum sweep pitch angle;

FIG. 5 is a side view of one embodiment of a rear sweep indicating a minimum sweep angle;

FIG. 6a is a front view of a rear sweep with a hilling shield attached;

FIG. 6b is a side view of the rear sweep shown in FIG. 6a with a hilling shield attached;

FIG. 6c is a perspective view of the rear sweep shown in FIGS. 6a and 6b with a hilling shield attached;

FIG. 7 is a perspective view of a row crop cultivator row unit including a coulter;

FIG. 8 is a top view of the sweep and coulter configuration shown in FIG. 7;

FIG. 9 is a perspective view of an alternative embodiment of a sweep configuration for a row crop cultivator row unit;

FIG. 10 is a perspective view of the row crop cultivator row unit shown in FIG. 9 including a coulter;

FIG. 11 is a top view of the sweep and coulter configuration shown in FIG. 10;

FIG. 12 is a perspective view of another alternative embodiment of a sweep configuration for a row crop cultivator row unit;

FIG. 13 is a perspective view of the row crop cultivator row unit shown in FIG. 12 including a coulter;

FIG. 14 is a top view of the sweep and coulter configuration shown in FIG. 13; and

FIG. 15 is a front view of front sweeps each with a hilling shield attached.

### DETAILED DESCRIPTION OF THE EMBODIMENTS

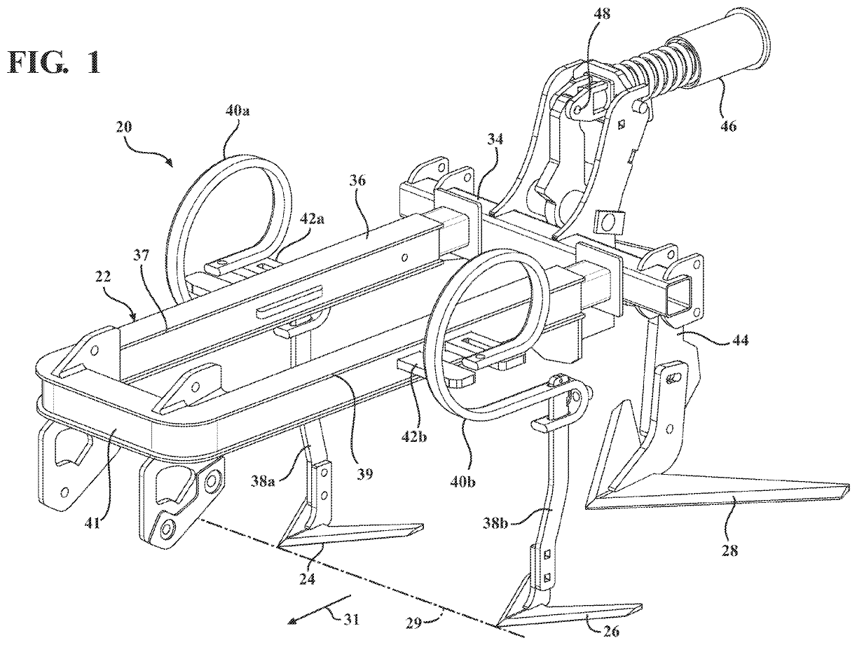

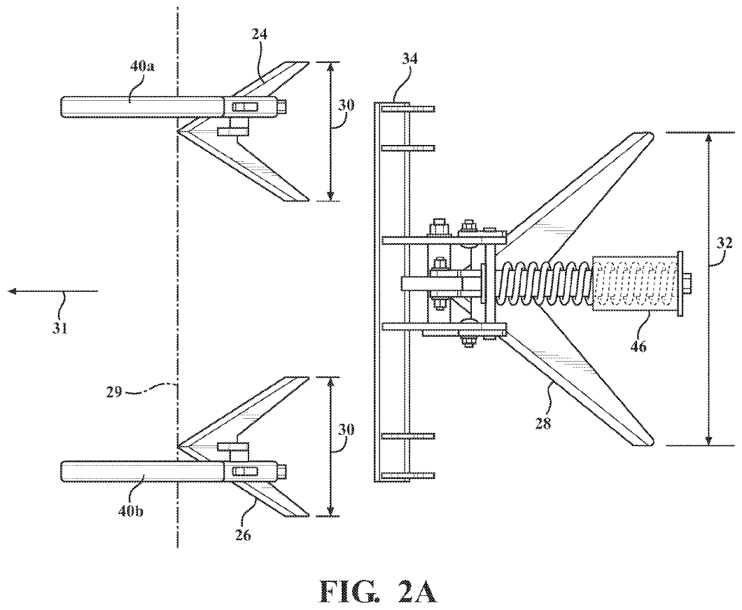

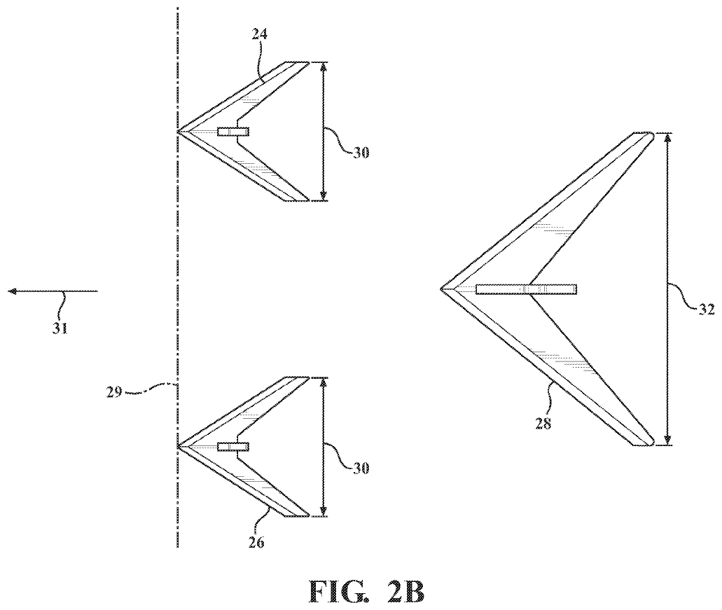

Referring to the Figures, wherein like numerals indicate like or corresponding parts throughout the several views, a row unit for cultivating agricultural crops within a field is shown generally at 20. Multiple row units in parallel form a row crop cultivator. Referring to FIG. 1, the row crop unit includes a frame 22, two front sweeps 24, 26 attached to the frame 22, and a rear sweep 28 attached to the frame 22. The rear sweep 28 is positioned rearwardly and between the two front sweeps 24, 26. Referring to FIGS. 2a and 2b, the two front sweeps 24, 26 are preferably uniform in size, adjacent to each other, and aligned spaced apart along an imaginary line 29 running between them, wherein the imaginary line 29 is perpendicular to a direction of travel 31 of the row crop cultivator.

For a specific sweep, its size is determined by its maximum width measurement 30. Further, the size of the rear, larger sweep 32, which is determined by its maximum width measurement, is dependent upon the size of the front, identically sized, smaller sweeps 30. Preferably, the rear sweep size 32 is within the range of 1.5 to 6 times larger than the size of the front sweep 30. In one example, the size of each front sweep is 6 inches. Accordingly, the size of the rear sweep will be in the range of 9 inches-36 inches.

Referring back to FIG. 1, the frame 22 includes a rear cross member section 34 and a front section 36 that are rigidly connected to each other. The frame front section 36 is generally U-shaped having two parallel sections 37, 39 connected together by a connecting section 41. Each front sweep 24, 26 is connected to a shank 38a, 38b. Each shank 38a, 38b is connected to a coil spring 40a, 40b and each coil spring 40a, 40b is connected to one of the parallel sections 37, 39 on the front section 36 of the frame 22. The two front sweeps 24, 26 can be adjusted inwardly or outwardly along a mounting bracket 42a, 42b as appropriate for the type of crop and/or row width to be cultivated. Similarly, the rear sweep 28 is connected to a rear shank 44 which is connected to the rear cross member section 34 of the frame 22.

The row unit 20 may be attached to an agricultural machine (not shown) via attachment to a beam extending outwardly from the agricultural machine (not shown) in a direction perpendicular to the direction of travel 31. Multiple row units may be attached to the beam depending on desired number of rows of crops to be cultivated.

In one embodiment, the frame 22 may include a damper spring with reset functionality 46. This configuration maintains each row crop cultivator row unit 20 rigidly in its position unless a large object, such as a rock, is encountered. If a large object is encountered, the damper spring 46 allows the frame 22 to pivot about a hinged pivot point 48 and then rebound back to its default position.

The rear sweep 28 has a low profile geometry. Referring to FIG. 3, the rear sweep has a height of preferably 19.55 mm, measured from a lower surface 52 to an upper surface 54 of the sweep 28. Further, the rear sweep height is preferably no greater than 25 mm. The sweep height is measured perpendicular to the ground.

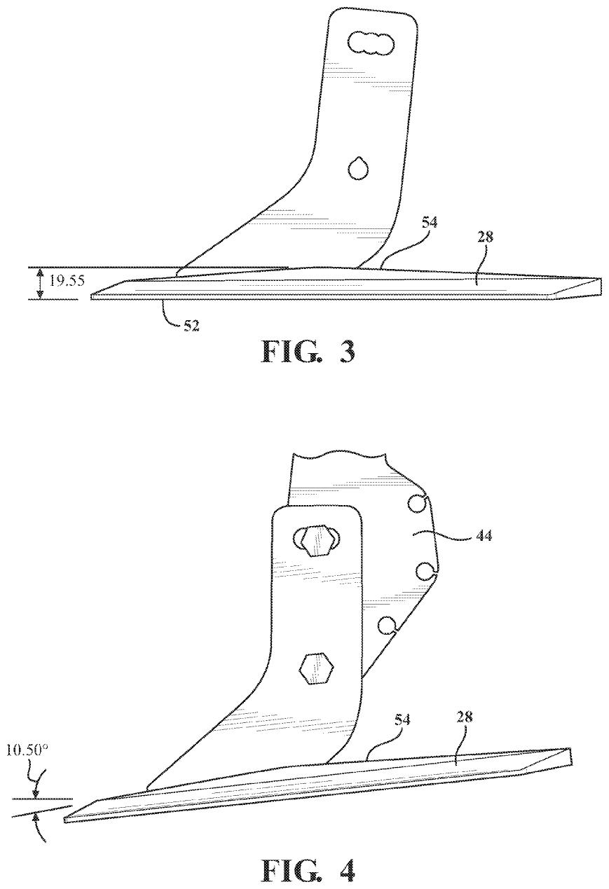

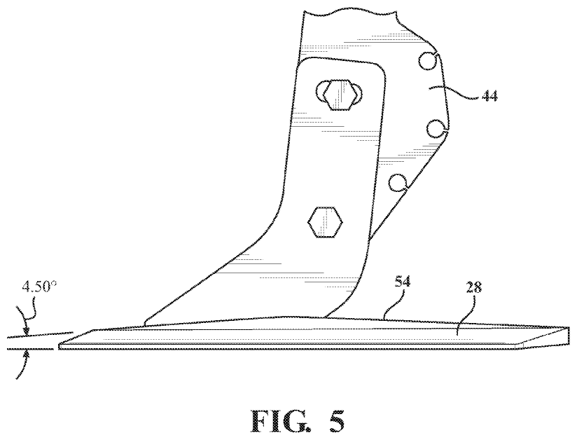

Referring to FIG. 4, the rear sweep 28 preferably has a minimum sweep pitch angle of 4.50°. Referring to FIG. 5, the rear sweep 28 preferably has a maximum sweep pitch angle of 10.50°. Further, the rear sweep 28 has a sweep pitch angle that is between 0° and 12°. The sweep pitch angle is the maximum angle of the upper surface 54 of the sweep relative to the ground with the agricultural machine beam level to the ground.

In operation, the row unit 20 is mounted on the agricultural machine as is known in the art and travels along the field containing the crops to be harvested. The desired number of row units are attached to the agricultural machine extending out from either one or both sides of the agricultural machine. As the agricultural machine travels forward, the sweeps 24, 26, 28 of each row unit slice through the soil and weeds between the rows of planted crops. The front sweep configuration allows for symmetrical soil flow and transfers an equal amount of soil in either direction of each sweep perpendicular to the direction of travel. The placement of the rear sweep provides for minimal soil flow into the row at high speeds, typically between 5-10 miles per hour, allowing for high-speed cultivation during early growth stages of the crop.

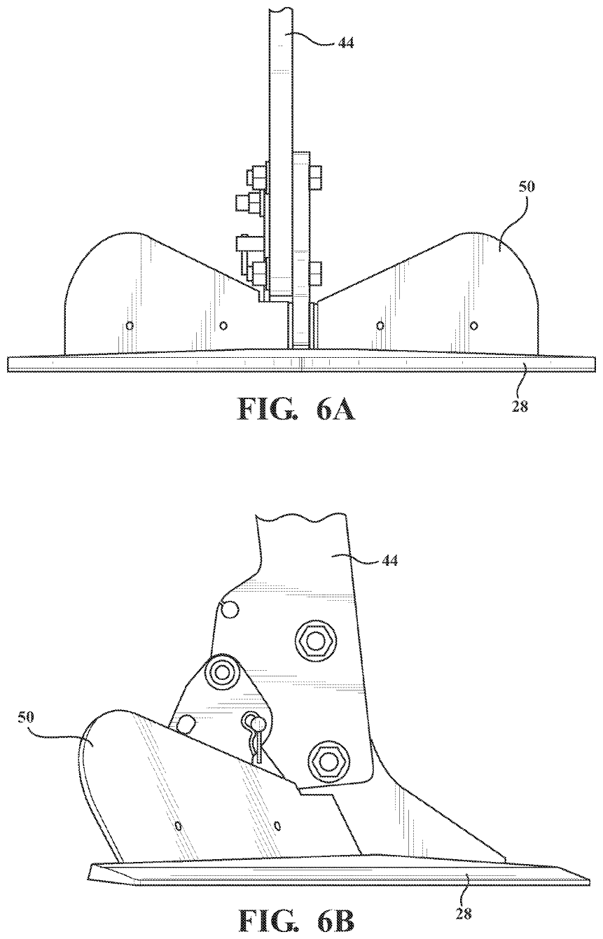

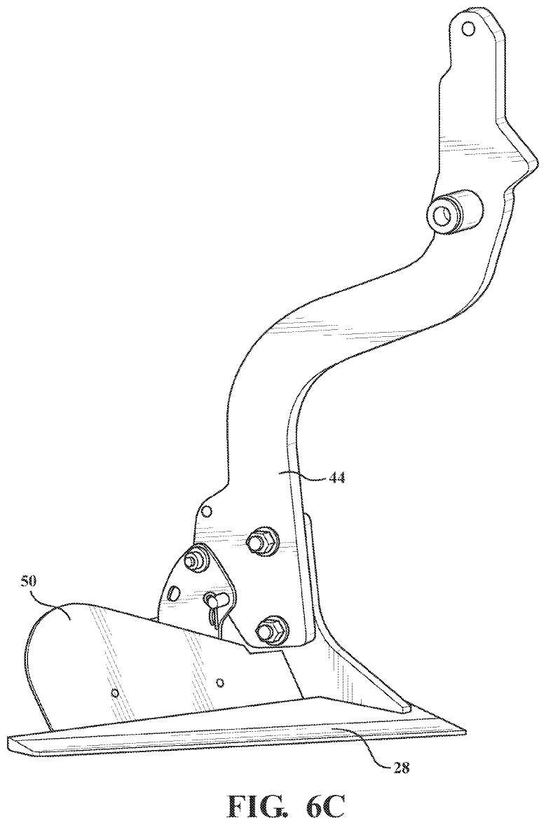

A hilling shield 50 is an optional component that can be added to allow the row unit to be effective for hilling in tall crops, as shown in FIGS. 6a-6c. The hilling shield 50 is mounted over the rear sweep 28. In one embodiment, the hilling shield 50 is attached to the rear shank 44, in a known conventional manner, and fits tightly against the rear sweep 28.

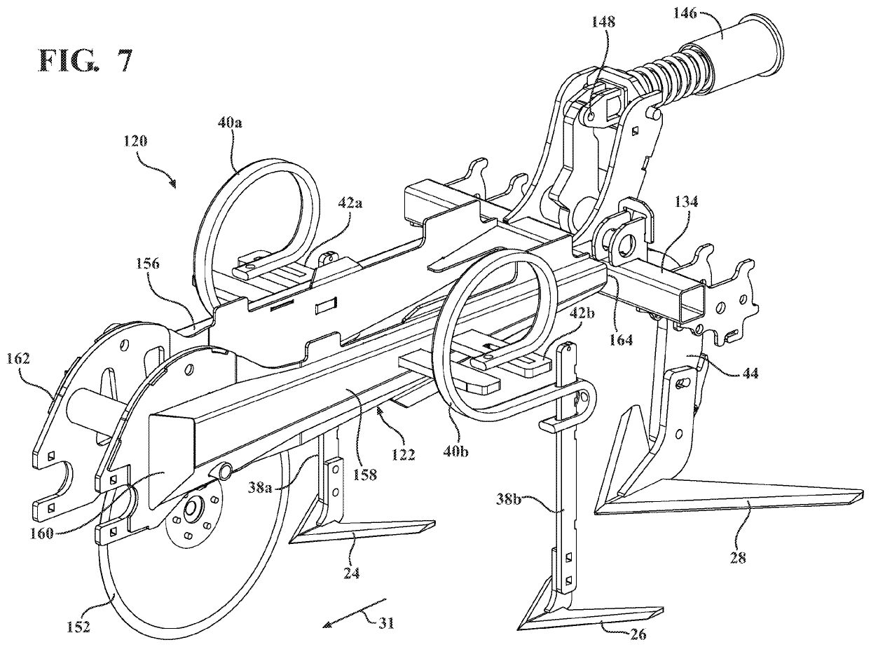

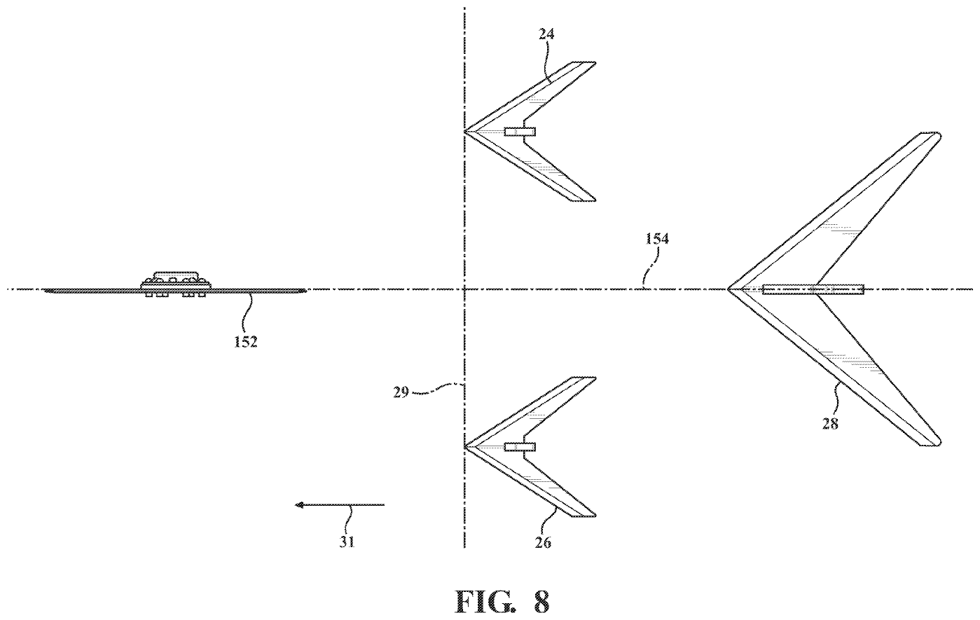

A coulter 152 may optionally be attached to the frame to vertically cut into the soil. FIG. 7 illustrates a row unit including a coulter 152, shown generally at 120. The row unit 120 includes the two front sweeps 24, 26, the rear sweep 28, and coulter 152 attached to frame 122. Referring to FIG. 8, the coulter 152 is positioned forwardly with respect to the two front sweeps 24, 26, between the two front sweeps 24, 26, and in longitudinal alignment 154 with the rear sweep 28. Arrow 31 indicates the direction of travel of the agricultural machine to which the row unit 120 is attached.

Referring to FIG. 7, frame 122 includes a first side member 156 and a second side member 158 that are each rigidly attached to a rear member 134. First side member 156 is a mirror image of second side member 158. The total height dimension of the first side member 156 and the total height dimension of the second side member 158 varies from the front 160 of each side member to the rear of each side member. The rear of each side member 156, 158 is where each side member 156, 158 connects to rear member 134. The total height dimension 162 at the front of second side member 158 is greater than the total height dimension 164 at the rear of second side member 158. Although not visible in FIG. 7, the total height dimension at the front of first side member 156 is greater than the total height dimension at the rear of the fist side member 156.

Each front sweep 24, 26 is connected to a shank 38a, 38b. Each shank 38a, 38b is connected to a coil spring 40a, 40b. Coil spring 40a is connected to first side member 156. Coil spring 40b is connected to second side member 158. The two front sweeps 24, 26 can be adjusted inwardly or outwardly along a mounting bracket 42a, 42b as appropriate for the type of crop and/or row width to be cultivated. Similarly, the rear sweep 28 is connected to a rear shank 44 which is connected to the rear cross member section 134 of the frame 122.

The row unit 120 may be attached to an agricultural machine (not shown) via attachment to a beam extending outwardly from the agricultural machine (not shown) in a direction perpendicular to the direction of travel 31. Multiple row units may be attached to the beam depending on desired number of rows of crops to be cultivated.

Frame 122 may include a damper spring with reset functionality 146. This configuration maintains each row crop cultivator 120 rigidly in its position unless a large object is encountered. If a large object is encountered, the damper spring 146 allows the frame 122 to pivot about a hinged pivot point 148 and then rebound back to its default position.

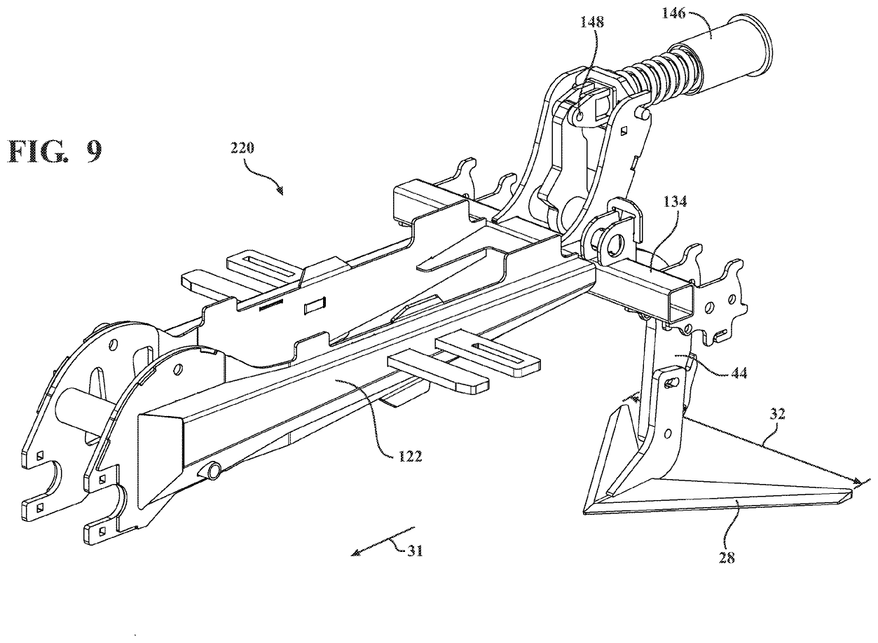

Referring to FIG. 9, an alternative embodiment of the row crop unit, shown generally at 220, includes only sweep 28 attached to frame 122. As previously described and shown in FIGS. 3-5, the sweep 28 has a maximum width dimension 32 in the range of 9 inches-36 inches, a maximum height of 25 millimeters measured from its lower surface 52 to its upper surface 54, and a sweep pitch angle in the range of 0° and 12°, which is the angle of the upper surface 54 of the sweep 28 relative to the ground with the agricultural machine beam level to the ground. Sweep 28 is connected to a rear shank 44 which is connected to the rear cross member section 134 of the frame 122.

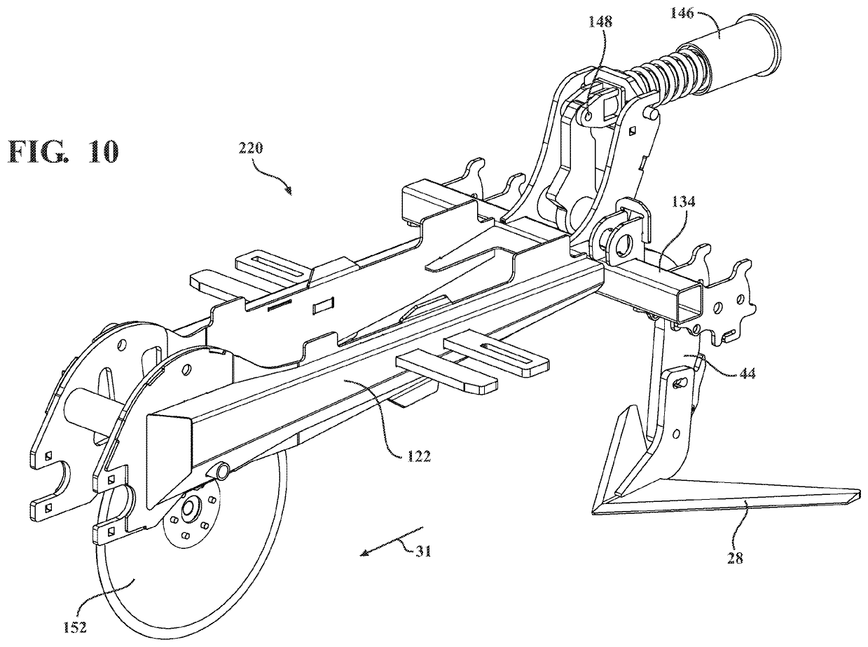

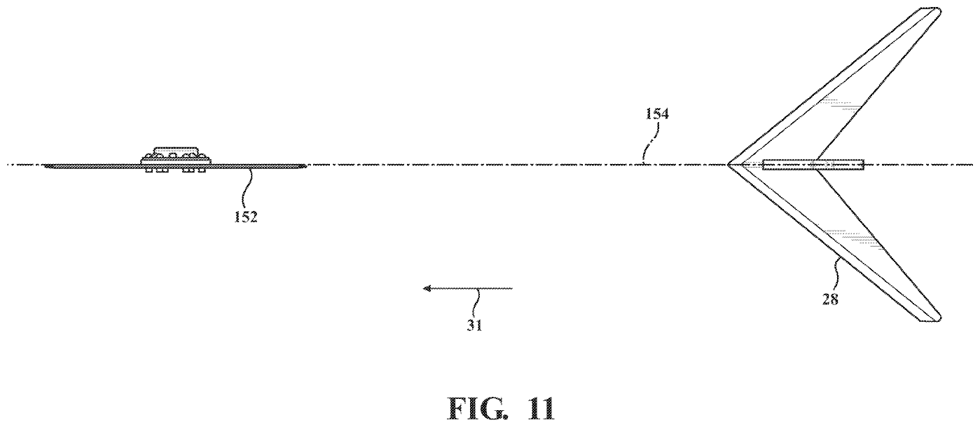

Referring to FIGS. 10 and 11, a coulter 152 may optionally be mounted to the frame 122. The coulter 152 is attached to the frame 122 forwardly and in longitudinal alignment 154 with respect to sweep 28. Sweep 32 is connected to shank 44 and shank 44 is connected to rear cross member section 134 of frame 122. Arrow 31 indicates the direction of travel. Further, a hilling shield 50 may also optionally be used in combination with sweep 28, as shown in FIGS. 6a-6c, either when the coulter 152 is attached to frame 122 or when the coulter 152 is not attached to frame 122.

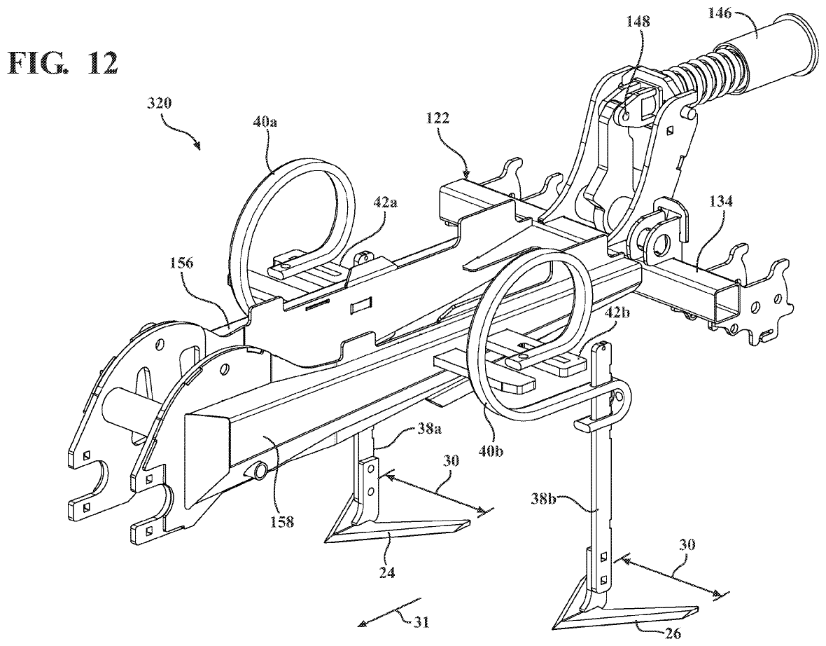

Referring to FIG. 12, another alternative embodiment of the row crop unit, shown generally at 320, includes two sweeps 24, 26 attached to frame 122. The two sweeps 24, 26 have generally identical dimensions with each sweep 24, 26 having a maximum width dimension 30 in the range of 5 inches-7 inches. Sweep 24 is connected to shank 38a. Shank 38a is connected to coil spring 40a and coil spring 40a is connected to first side member 156 of frame 122. Sweep 26 is connected to shank 38b. Shank 38b is connected to coil spring 40b and coil spring 40b is connected to second side member 158 of frame 122. The two front sweeps 24, 26 can be adjusted inwardly or outwardly along mounting brackets 42a, 42b as appropriate for the type of crop and/or row width to be cultivated.

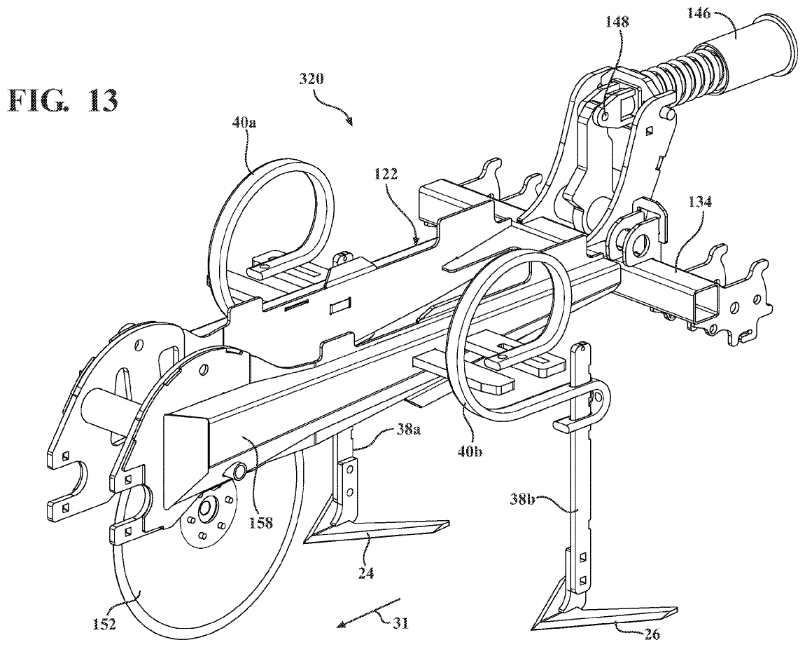

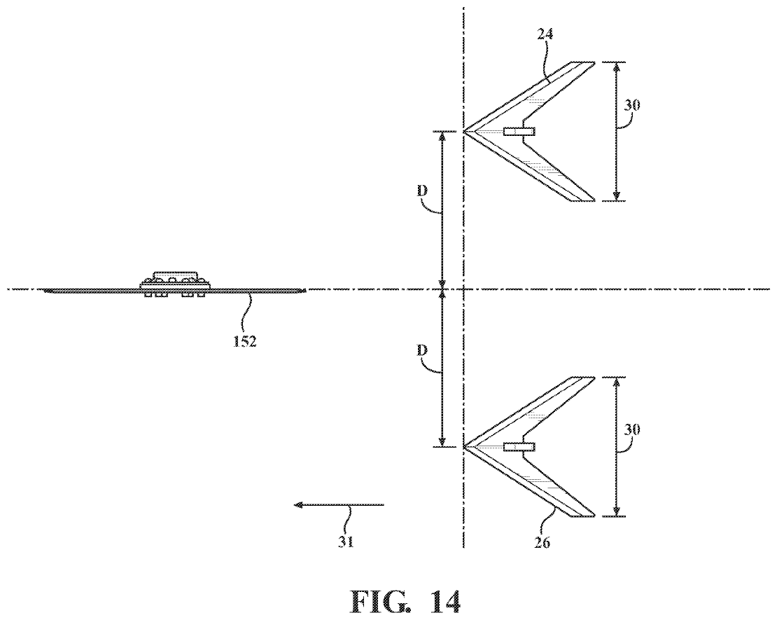

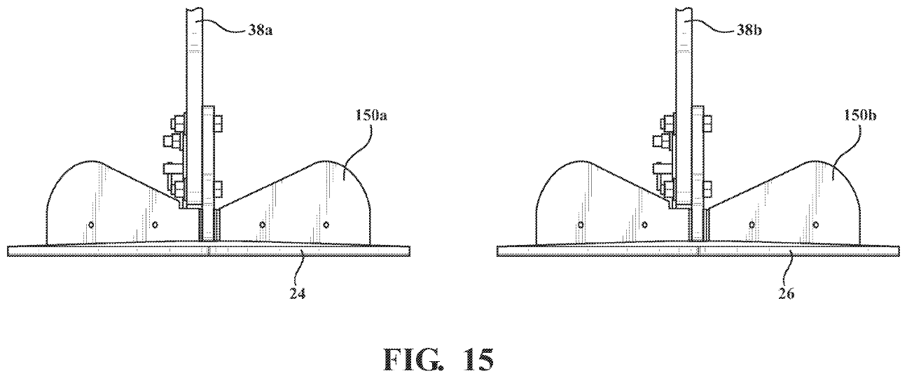

Referring to FIGS. 13-14, a coulter 152 may optionally be mounted to the frame 122. The coulter 152 is attached to the frame 122 forwardly and centered, by distance D, between sweeps 24, 26. Arrow 31 indicates the direction of travel.

Referring to FIG. 15, hilling shields 150 may also optionally be mounted to both sweeps 24, 26, either when the coulter 152 is attached to frame 122 or when the coulter 152 is not attached to frame 122. Hilling shields 150a is mounted over, fitting tightly against sweep 24 and is attached to shank 38a in a known conventional manner. Hilling shield 150b is mounted over, fitting tightly against sweep 26 and is attached to shank 38b in a known conventional manner.

It should be noted that frame 22 and frame 122 are not limiting and can be used interchangeably between the multiple embodiments. In other words, where frame 22 is described above, frame 122 could be used instead. Similarly, where frame 122 is described above, frame 22 could be used instead.

The invention has been described in an illustrative manner, and it is to be understood that the terminology which has been used is intended to be in the nature of words of description rather than of limitation. Directional references employed or shown in the description, figures or claims, such as top, bottom, upper, lower, upward, downward, lengthwise, widthwise, longitudinal, lateral, and the like, are relative terms employed for ease of description and are not intended to limit the scope of the invention in any respect. Many modifications and variations of the present invention are possible in light of the above teachings. It is, therefore, to be understood that within the scope of the appended claims, the invention may be practiced other than as specifically described.

1. A row crop cultivator row unit comprising:
a frame;
two front sweeps attached to the frame;
a rear sweep, attached to the frame, positioned rearwardly and between the two front sweeps;
wherein the two front sweeps are uniform in size, each having a maximum width identical to the other, and the rear sweep has a maximum width that is larger than the front sweep maximum width.

2. The row crop cultivator row unit of claim 1, wherein the rear sweep maximum width is within the range of 1.5 to 6 times larger than the maximum width of the front sweep.

3. The row crop cultivator row unit of claim 1, wherein the two front sweeps are adjacent to each other, aligned spaced apart along an imaginary line running between them, wherein the imaginary line is perpendicular to a direction of travel of the row crop cultivator.

4. The row crop cultivator row unit of claim 1, wherein the rear sweep has a height no greater than 25 mm.

5. The row crop cultivator row unit of claim 4, wherein the rear sweep has a height of 19.55 mm.

6. The row crop cultivator row unit of claim 1, wherein the rear sweep has a sweep pitch angle in the range of 0° to 12°.

7. The row crop cultivator row unit of claim 6, wherein the minimum rear sweep pitch angle is 4.5° and the maximum rear sweep pitch angle is 10.5°.

8. The row crop cultivator row unit of claim 1, further comprising a damper spring reset attached to the frame.

9. The row crop cultivator row unit of claim 1, further comprising a hilling shield mounted over the rear sweep.

10. The row crop cultivator row unit of claim 1, further comprising a coulter attached to the frame.

11. The row crop cultivator row unit of claim 10, wherein the coulter is positioned forwardly with respect to the two front sweeps, between the two front sweeps, and in longitudinal alignment with the rear sweep.

12. The row crop cultivator row unit comprising:
a frame; and
a sweep, attached to the frame, wherein:
the sweep has a maximum width dimension in the range of 9 inches-36 inches;
the sweep has a maximum height of 25 millimeters, measured from a lower surface to an upper surface; and
the sweep has a sweep pitch angle in the range of 0° to 12°, measured from the upper surface relative to a horizontal ground.

13. The row crop cultivator row unit of claim 12, further comprising a coulter attached to the frame, positioned forwardly from and in longitudinal alignment with respect to the sweep.

14. The row crop cultivator row unit of claim 13, further comprising a damper spring reset attached to the frame.

15. The row crop cultivator unit of claim 13, further comprising a hilling shield mounted over the sweep.

16. The row crop cultivator row unit comprising:
a frame; and
two sweeps, attached to the frame, wherein:
the two sweeps have identical dimensions;
each sweep has a maximum width dimension in the range of 5 inches-7 inches.

17. The row crop cultivator row unit of claim 16, further comprising a coulter attached to the frame, wherein the coulter is positioned forwardly from and centered between the two sweeps.

18. The row crop cultivator row unit of claim 17, further comprising a damper spring reset attached to the frame.

19. The row crop cultivator row unit of claim 17, further comprising two hilling shields, wherein one hilling shield mounted over each sweep.
